(19) United States
(12) Patent Application Publication
(10) Pub. No.: US 2003/0227922 A1
(43) Pub. Date: Dec. 11, 2003

(54) Method for alternate routing of communication connections

(76) Inventors: Ernst Horvath, Wien (AT); Johannes Winter, Wien (AT); Klaus Wile, Munich (DE)

Correspondence Address: STAAS & HALSEY LLP, SUITE 700, 1201 NEW YORK AVENUE, N.W., WASHINGTON, DC, 20005, US

(21) Appl. No.: 10/446,186

(22) Filed: May 28, 2003

(30) Foreign Application Priority Data
May 29, 2002 (DE) 10223980.0

(51) Int. Cl. H04L 12/28

(52) U.S. Cl. 370/395.3; 370/457

(57) ABSTRACT

Communication connections in a communication system with a communication terminal are assigned to a first communication device, which can be registered at a second communication device, and used in a packet-oriented network by way of which the communication terminal is connected to the first and the second communication devices. As a consequence of a registration performed by a subscriber the communication terminal is signed off from the first communication device and is assigned to the second communication device. In the case of a communication connection initialized at the communication terminal a check is carried out to determine whether the initiated communication connection to a destination device defined by a subscriber number reserved in the communication system is to be realized. In the case of a positive outcome to the check a determination of the destination device is performed taking into consideration information characterizing the location of the communication terminal which is available in the communication terminal, whereupon the communication connection is established to a destination device assigned to the first communication device.

### CROSS REFERENCE TO RELATED APPLICATIONS

This application is based on and hereby claims priority to German Application No. 10223980.0 filed on May 29, 2002, the contents of which are hereby incorporated by reference.

### BACKGROUND OF THE INVENTION

1. Field of the Invention

The invention relates to a method for the alternate routing of communications connections in packet-oriented networks under the control of communications devices.

2. Description of the Related Art

In modern communications systems the emphasis is increasingly moving over to sending continuous data streams by way of packet-oriented networks, for example for voice or video communications and also data for the control and checking of communications connections. The packet-oriented networks include LANs (Local Area Network), MANs (Metropolitan Area Network), WANs (Wide Area Network), or also the so-called Internet which enables worldwide access to data transmitted in packet-oriented fashion. For example, so-called Internet telephony, which is frequently also referred to as “Voice over Internet Protocol” (VoIP), is based on this technology.

In the field of telecommunications, communications devices are increasingly known which, in addition to commonly encountered communications connections, based on a circuit-switching principle, also allow support for the VoIP method and enable the connection of VoIP communications terminals.

In contrast to decentralized communications systems based on so-called peer-to-peer configurations, in which both control of communications and also control of switching between the communications terminals is undertaken without a central communications device, the aforementioned communications devices, extended to include a VoIP functionality, also perform a central control function in the case of VoIP communications terminals in respect of the switching of communications connections.

For this purpose, each VoIP communications terminal is registered at its assigned communications device with associated subscriber data such as, for example, the subscriber number, subscriber authorizations etc. Each VoIP communications terminal is therefore assigned by way of the packet-oriented network to a communications device associated with it which is likewise connected to the packet-oriented network. The packet-oriented network generally encompasses the entire communications system, in other words access to the packet-oriented network is possible at any point in the communications system. For its part, each possible communications partner is accessible at each possible access point.

In the communications system it is normal for reserved subscriber numbers standardized throughout the network to be allocated according to a so-called numbering scheme is normal. These reserved subscriber numbers typically include emergency numbers which for example are standardized in Germany to the number “112” and in the United States to the number “911”. If a subscriber dials an emergency number of this type he must be able to expect to be connected to a central control point—an emergency services control center—which is located in his immediate vicinity and is able to initiate local rescue actions. In order to facilitate exact localization of the location of the emergency call by the emergency services, the concept of a local identification number LIN (Location Identification Number) is frequently also used. This LIN which is specific to each communications terminal is sent to the emergency services control center with every emergency call and enables the emergency services control center to determine the location of the emergency call even in situations in which the calling subscriber is not capable of determining the location of the emergency call or of expressing it in words.

Modern communications systems frequently offer the functionality of a “mobile subscriber”. This is understood to mean that a subscriber is able to personalize practically any communications terminal within a communications system as his own. In order to perform this personalization, the mobile subscriber must register at a communications terminal of his choice by entering a user number that has been assigned to him—his subscriber number for example—and a personal identification number: Instead of this input, registration by a chipcard is also commonly used.

The registration of a mobile subscriber at a communications terminal of his choice is also possible in a communications system consisting of a pool of a plurality of communications devices. In a pool of this type, one communications device is frequently assigned to a particular subscriber as a so-called home station. The subscriber data for the respective subscriber is stored on the home station.

In the event of the subscriber switching to a—“visited”—communications terminal assigned to a second communications device, the subscriber data associated with the subscriber is sent from the home station to the second communications device and this subscriber data is stored in the second communications device or, if need be, in the visited communications terminal. Communications devices to which communications terminals are assigned by way of a permanently allocated line and an adapter unit permanently allocated to the respective communications terminal, assume control of switching and communications after receiving the subscriber data without the involvement of the home station of the mobile subscriber. With a registration at a communications terminal assigned to a different communications device, the mobile subscriber has clearly “switched” communications device, although naturally no change has occurred in respect of his subscriber number or in respect of his caller identification for outgoing connections.

For communications systems in which the communications terminals—VoIP communications terminals—are connected to the communications devices by way of a packet-oriented network, the aforementioned switch in the communications unit executing the control and switching functions is not necessary since the home station is also accessible from the visited communications terminal by way of the packet-oriented network in the entire communications system. Instead—following a login operation at the initially assigned second communications device—the visited VoIP communications terminal is assigned to the home station of the mobile subscriber.

In the case where communications terminals are connected by way of a packet-oriented network to a pool of communications devices, this results in the problem for mobile subscribers that as a result of an often nationwide coverage offered by the communications system a communications connection established to reserved numbers standardized throughout the network is put through to a central control point assigned to this reserved number which may under certain circumstances be located at a great distance from the calling communications terminal. This situation occurs, for example, in the case of communications systems designed to have wide coverage when a mobile subscriber assigned to a home station in a city A registers at a—visited—VoIP communications terminal in a city B.

For the situation where a mobile subscriber has registered at a communications terminal which is situated in a different city B—or, in the case of communications systems which cross national borders, even in a different country—than that in which the terminal assigned to him—or his home station—is located, the situation occurs, in the case of a communications system consisting of a pool of communications devices, that when an emergency call is made by the mobile subscriber the communications connection is routed by way of the packet-oriented network to his home station—located in city A—in other words the communications connection is put through to an emergency services control center totally remote from the location of the emergency call, which is assigned to the home station in city A.

### SUMMARY OF THE INVENTION

An object of the invention is to provide measures which enable a mobile subscriber in a communications system equipped with a packet-oriented network for linking the communications terminals to a pool of communications devices, when dialing reserved subscriber numbers, to have the call put through to local central control points.

According to the invention, information characterizing the location of the communications terminal is present at a visited communications terminal.

With regard to a method according to the invention, a check is first carried out to determine whether the initiation of a communications connection to a reserved destination—in particular an emergency services control center—is being requested by a —mobile—subscriber who has registered at this communications terminal. This check is performed either in the communications terminal or in a communications device assigned to the communications terminal. This communications device assigned to the communications terminal is for example the communications device which is used for administration of the communications terminal. Administration takes the form, for example, of software updates or maintenance actions.

In the event of a communications connection to a reserved destination being requested the information characterizing the location of the communications terminal is taken into consideration for determining the reserved destination. The information is taken into consideration for example in a manner whereby the information is sent to the communications device by the communications terminal in addition to the dial information. The communications device then determines whether the information sent matches the data relating to the location of the communications device which is present on the communications device. If there is no match, the reserved destination is determined by taking into consideration the information characterizing the location of the communications terminal.

One important advantage of the method according to the invention lies in the implementation of an important aspect concerning safety requirements which makes possible a connection to the nearest emergency services control center or similar local centralized facilities.

A further advantage of a method according to the invention can be seen in the fact that no costly software or hardware changes need to be made to the respective communications terminal or to the communications devices.

Advantageously, the information for a subscriber number which is unique throughout a communications system is present on the communications terminal of the mobile subscriber. A subscriber number which is unique throughout the network in this context is taken to mean that the subscriber number of the reserved destination is stored for example with a complete “prefix”, in particular therefore in the form of an international and national dialing code. For example, the network-wide unique subscriber number has the form “+49 89 230 110”, where “+49” is the international dialing code for Germany, “89” is the dialing code for the city—in this example the city is Munich—, “230” for example stands for the access number of the central communications device or of a number range for the communications system, and “110” stands for the emergency number valid within this number range.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a communications system CSY with a packet-oriented network LAN accessible in the entire communications system CSY.

FIG. 2 is a flowchart illustrating the essential operations occurring in the method according to the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

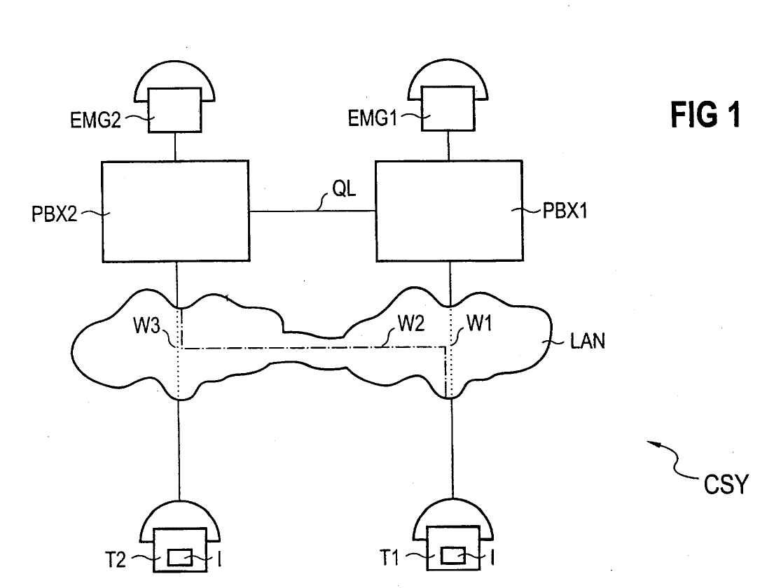

As illustrated in FIG. 1, two communications devices PBXI, PBX2 and also two communications terminals T1, T2 are connected to the packet-oriented network LAN. In accordance with this connection configuration, the two communications terminals T1, T2 support a packet-oriented exchange of user or signaling data; they are therefore implemented as VoIP communications terminals T1, T2 (Voice over Internet Protocol), for example.

In this situation, signaling data typically includes information required for connection control, signaling etc., whereas user data includes voice or video communications data.

The two communications devices PBX1, PBX2 are interconnected by a tie line QL for exchanging data. The tie line QL can be implemented either as a “virtual” connection across the packet-oriented network LAN, or can also—as represented in the drawing—be present in the form of a permanent connecting line.

Furthermore, a first communications terminal EMG1 assigned to a destination having a reserved subscriber number in the communications system (CSY) is connected to the first communications device PBXI, and a second communications terminal EMG2 assigned to a destination having a reserved subscriber number in the communications system (CSY) is connected to the second communications device PBX2.

For reasons associated with failsafe operation, neither of the two communications terminals EMG1, EMG2 assigned to a reserved destination are connected to the respective communications devices PBXI, PBX2 by way of the packet-oriented network LAN. However, given an appropriate level of data transmission reliability, it is also possible to implement a configuration of these two communications terminals EMG1, EMG2 as VoIP communications terminals and consequently connect them to the packet-oriented network LAN.

Information I characterizing the location of the respective communications terminal T1, T2 is stored in the VoIP communications terminals T1, T2.

This information I is stored for example as a subscriber number unique in the communications system with a complete “prefix”, whereby the prefix consists of an international and national dialing code, for example in the form “+49 89 230 110”, where “+49” is the international dialing code, “89” is the dialing code for the city—in this example the city is Munich—, “230” for example stands for the access number of the central communications device or of a number range for the communications system, and “110” stands for the emergency number valid within this number range.

In an alternative embodiment, the information I characterizing the location of the respective communications terminal T1, T2 is available in the form of geographical coordinates. To this end, this information I will have been sent to the telecommunications terminals T1, T2 by the respective assigned communications device PBX1, PBX2 at the time the communications terminals T1, T2 are set up or being administered. Alternatively, this information I is generated dynamically, for example by a unit (not shown) for the reception and evaluation of satellite signals—GPS signals (Global Positioning System)—for determining position in the form of geographical coordinates.

The information I characterizing the location of the respective communications terminal T1, T2 is alternatively available in the form of a node number unique in the packet-oriented network LAN or in the form of an identification number for the respective communications terminal T1, T2. With the aid of the latterly mentioned identification number, by using assignment tables (not shown) it is possible to perform an assignment in an involved communications device to the location of the respective communications terminal. An identification number of this type is, for example the so-called Line Identification Number, LIN, which is prescribed by law in some countries. A further possible way of defining the identification number is to use an IP (Internet Protocol) address which is unique across the entire packet-oriented network.

Incidentally, the drawing represents only one section of a complex communications system CSY which in real technical realizations contains further functional units—such as, for example, systems known to experts as “Gatekeepers” for managing the packet-oriented data traffic, as well as further forms of control computers, network node devices etc.—and also a fairly large number of communications devices and communications terminals.

Communications terminals T1, T2 can also be designed in the form of mobile communications systems such as, for example, mobile communications terminals, PDAs (Personal Digital Assistant) etc. In particular, an embodiment taking the form of data processing computer units, such as personal computers (PCs) for example, also suggests itself to the expert.

No permanently connected conductor paths exist in a packet-oriented network LAN. The dot-and-dash and solid lines shown in the drawing for conductor paths W1, W2, W3 are accordingly to be understood as pictorial representations of possible conductor paths in the—otherwise connectionless—packet-oriented network LAN and serve to illustrate packet-oriented data streams.

In the following it is assumed that the second communications terminal T2 is permanently assigned to a subscriber—also referred to as “mobile” subscriber in the following. By a signaling and user data connection W3 via the packet-oriented network LAN, the second communications terminal T2 is assigned to the second communications device PBX2 which has stored its subscriber data and is therefore referred to in the following as the “home station” of the subscriber assigned to the second communications terminal T2.

The first communications terminal T1 is assigned to the first communications device PBX1 by way of the signaling and user data connection WI. This first communications terminal T1 is for example a so-called “shared desk telephone”, in other words a communications terminal T1 which as a result of registration can be used temporarily by a subscriber who will find it personalized to his settings.

For further illustration, it is assumed that the first communications device PBX1 and its assigned first communications terminal T1 are located in the city of Munich. The location of the second communications device PBX2 and its assigned second communications terminal T2 is assumed to be the city of Vienna.

Let us assume that the mobile subscriber whose workplace telephone for his company, the second communications terminal T2, is located in Vienna is currently in Munich on business and registers for this purpose at a communications terminal, the first communications terminal T1, in a “shared desk area” by entering his personal identification number and his subscriber number valid at the second communications device T2.

During the course of the ensuing registration process the first communications device PBX1 assigned to the first communications terminal T1 communicates with the home station PBX2 of the mobile subscriber. When the registration takes place at the first communications terminal T1, the home station PBX2 receives a subscriber number or node number for the communications device PBX1 controlling this communications terminal T1, as well as an identification number for the first communications terminal T1. The identification number for the VoIP communications terminal T1 is available, for example, in the form of a port number set up on a network node device (not shown) also referred to as a “gateway”.

When the “Mobile User” service feature is selected at the first communications terminal T1, as a result of an inquiry from the second communications device PBX2—home station—made over the tie line QL the first communications device PBX1 receives an IP address (Internet Protocol), the subscriber number and the personal identification number of the first communications terminal T1.

When registration has taken place, the mobile subscriber at his Munich communications terminal T1 is connected to his home station PBX2 in Vienna by way of the packet-oriented network LAN; see connection path W2 in the drawing.

If an emergency situation occurs at his current location in Munich, the subscriber dials the emergency number “110” reserved within the communications system CSY at the first communications terminal T1. The connection request with the associated subscriber number to be dialed is transmitted together with the information I relating to the location of the communications terminal T2 to the home station PBX2 of the mobile subscriber. The information I relating to the location of the first communications terminal T1 is available in the embodiment in the form of a complete emergency number according to the above descriptions.

The information I relating to the location of the communications terminal T1 is either transmitted to the home station at the time of call establishment to this emergency number, or this happens, according to an alternative embodiment of the invention, immediately after registration of the mobile subscriber has taken place at the first communications terminal T1.

By comparing the information I relating to the location of the first communications terminal T1 with its own information relating to the location, the second communications device PBX2 determines that the location of the mobile subscriber is not situated in the segment managed by the second communications device PBX2—in this case the city of Vienna. The closest geographical location to the mobile subscriber for forwarding to a communications device PBX1 which will switch the emergency call through is consequently ascertained by an inquiry in a database (not shown) assigned to the second communications device PBX2. The second communications device PBX2 then forwards the emergency call outbound from the first communications device T1 by way of the first communications device PBX1 to the emergency services control center EMG1 assigned to this communications device PBX1—located at the location of the subscriber.

This forwarding is carried out either by way of the packet-oriented network LAN or by way of the tie line QL. With regard to the way in which the forwarding is processed, the method employing a so-called “intercept” is used, for example. This intercept is implemented, for example, by a “Call Interception” function which is available in a so-called QSIG protocol. The QSIG protocol (“Q-Interface Signaling Protocol”) is a protocol used within the framework of the ISDN protocol (Integrated Services Digital Network) for the transmission and processing of signaling information. Intercept is generally understood as the forwarding to a predefined destination if a call cannot be put through.

This intercept—also referred to as “Call Interception”—will be described in detail in the following. For this purpose, the home station PBX1 of the mobile subscriber does not switch the emergency call through to the local emergency services control center EMG2 but passes it on for onward switching to the first switching device PBXI. To this end, the “Called Party Number” used in QSIG, in other words the subscriber number of the destination to be called, is replaced by the node or subscriber number of the first communications device PBX1. In a “SETUP” message, an “Invoke” operation, in other words an invocation command, is inserted which contains as the intercept reasons—named in QSIG for example with an “interceptionCause” information element—the value “emergencyCall”, and also in a further “calledNumber” information element the emergency number to be called.

The contents of the “Calling Party Number” information element are changed from the local IP identification number to the subscriber number of the mobile subscriber, in other words the subscriber number assigned to his second communications terminal T2.

The first communications device PBXI, through which the first communications terminal T1 is actually administered, thus contains the emergency call and switches this through to the first emergency services control center.

In an alternative embodiment, all the emergency calls initiated in the communications system CSY are switched through to a central emergency call control computer (not shown) by the call interception method. This central emergency call control computer then determines a nearest emergency services control center by the transferred node or subscriber number of the communications device PBXI assigned to the calling communications terminal T1 and by the local identification number of the communications terminal T1 in assignment tables (not shown). For this embodiment, amongst other things the use of geographical coordinates is advantageous for the information I characterizing the location.

The method according to the invention is not restricted in its application to communications connections to emergency services control centers, emergency calls. Its application also extends to local information services, also referred to as “Location Based Services” by experts, which for example include timetable information services, telephone information services, etc.

In general, the method according to the invention can therefore be applied to all services—communications services, data-based or computer-supported information services for which information concerning the current location of a caller is important or useful for the service provider.

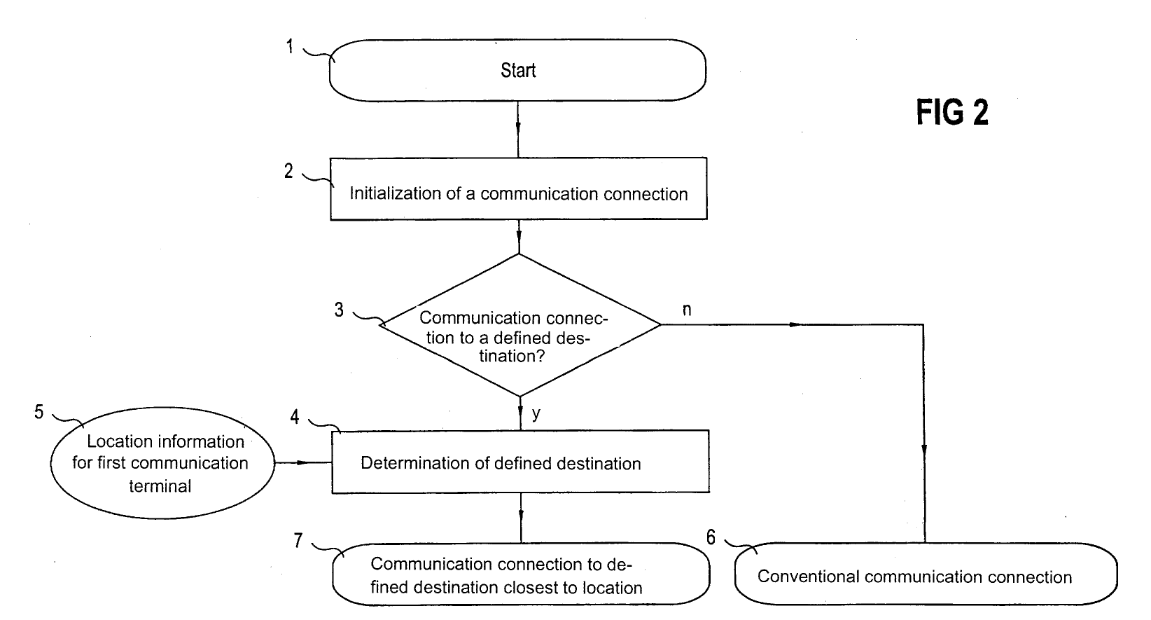

FIG. 2 is a flowchart in simplified representation which illustrates the emergency call handling method according to the invention. The method begins at “Start” 1, for example by a user lifting the handset of communications terminal T1 or, on his computer unit T1 supporting telephony functions, initiates an allocation of resources for a telecommunications connection which is to be established. Next is initialization of a communications connection 2, in which the subscriber dials a subscriber number at the first communications terminal T1 or enters this number at the computer unit T1 supporting telephony functions. Thereupon, a check 3 is performed as to whether the communications connection to be established is to be directed to a defined destination. This evaluation is performed for example on the basis of the subscriber number dialed by the user. If the result of this check is that the communication is not intended to be directed to a defined destination—this corresponds to the “No” branch, denoted in the drawing by “n”—then the communications connection in question is a conventional one whose further processing is handled 6 in accordance with known switching methods. However, if the result of the check 3 shows that the communication is intended to be directed to a defined destination, for example in the situation where a reserved subscriber number is recognized, further processing of is handled by choosing the “Yes” branch, denoted in the drawing by “y”. In this case, the location information 5, for the first communications terminal T1, is used in determining 4 the defined destination. After the defined destination has been determined 4, a communications connection to the defined destination closest to the location is established 7.

The invention has been described in detail with particular reference to preferred embodiments thereof and examples, but it will be understood that variations and modifications can be effected within the spirit and scope of the invention.

1. A method for alternate routing of communication connections in a communication system, comprising:
assigning a first communication terminal to a first communication device;
registering the first communication terminal at a second communication device, the first communication terminal and first and second communication devices being connectable by a packet-oriented network;
after said registering is performed by a subscriber, signing off the first communication terminal from the first communication device and assigning the first communication terminal to the second communication device;
first determining whether a communication connection to a destination device defined by a subscriber number reserved in the communication system is to be realized prior to initializing a communication connection at the first communication terminal;
if said first determining is positive, determining the destination device assigned to the first communication device using information available in the first communication terminal characterizing a location of the first communication terminal; and
establishing the communication connection between the first communication terminal and the destination device.

2. The method according to claim 1, wherein the communication connection connects the first communication terminal to a second communication terminal in at least one of an emergency center and emergency services control center.

3. The method according to claim 1, wherein the communication connection connects the first communication terminal to a second communication terminal at a local information center.

4. The method according to claim 3, wherein the information is the subscriber number which is unique throughout the communication system.

5. The method according to claim 3, wherein the information is geographical coordinates.

6. The method according to claim 3, wherein the information is a local identification number.

7. The method according to claim 3, wherein the information is an identification number which is unique in the packet-oriented network.

8. The method according to claim 7, wherein the information is transmitted from the first communication device to the first communication terminal at a time of at least one of commencement of operation and maintenance of the first communication terminal.

9. The method according to claim 7, wherein the information is determined independently by the first communication terminal.

10. The method according to claim 9, wherein said first determining is performed by the first communication terminal.

11. The method according to claim 9, wherein said first determining is performed by the second communication device.
